(19) United States
(12) Patent Application Publication
(10) Pub. No.: US 2014/0215106 A1
(43) Pub. Date: Jul. 31, 2014

(54) SVID DATA TEST SYSTEM AND METHOD

(71) Applicants: Hon Hai Precision Industry Co., Ltd., New Taipei (TW); Hong Fu Jin Precision Industry (ShenZhen) Co. Ltd., Shenzhen (CN)

(72) Inventor: SHENG-YI LI, Shenzhen (CN)

(73) Assignees: Hong Fu Jin Precision Industry (ShenZhen) Co., Ltd, Shenzhen (CN); HON HAI PRECISION INDUSTRY CO., LTD., New Taipei (TW)

(21) Appl. No.: 13/949,234

(22) Filed: Jul. 24, 2013

(30) Foreign Application Priority Data
Jan. 30, 2013 (CN) 2013100359950

(51) Int. Cl. G06F 13/38

(52) U.S. Cl. CPC G06F 13/387
USPC 710/71

(57) ABSTRACT

An SVID data test system is applied on a test device and a display device, and the test device is electrically connected to a tested device via an SVID interface, and the display device via a serial interface. The system receives SVID signals, analyzes the SVID signals to obtain nine bit real signals, and performs parallel encoding on the nine bit real signals to obtain nine bit parallel signals. The system further converts the nine bit parallel signals to nine bit serial signals, transmits the serial signals in sequence to the display device, and parses the nine bit serial signals to obtain a packet in hexadecimal and controls the display device to display the packet in response to the display command.

### BACKGROUND

1. Technical Field

The disclosure relates to test technology and, more particularly, to a serial voltage identification (SVID) data test system and a test method adapted for the SVID data test system.

2. Description of Related Art

The SVID bus protocol is utilized to monitor power supply of a circuit board. When testing SVID data, an oscillograph displays waveforms of the SVID signals, however, three waveforms represent one bit of the SVID signals and the SVID signals include nine bits, therefore, a user needs to look at and interpret very complex waveforms to determine characteristics of the power supply of the circuit board.

Therefore, what is needed is a SVID data test system to overcome the described shortcoming.

### BRIEF DESCRIPTION OF THE DRAWINGS

FIG. 1 is a block diagram of a test device including a SVID data test system in accordance with an exemplary embodiment.

FIG. 2 is a block diagram of the SVID data test system of FIG. 1.

FIG. 3 is a flowchart of an SVID data test method adapted for the SVID data test system of FIG. 2.

FIG. 4 is a schematic view showing relationships between each binary digit and a corresponding meaning.

### DETAILED DESCRIPTION

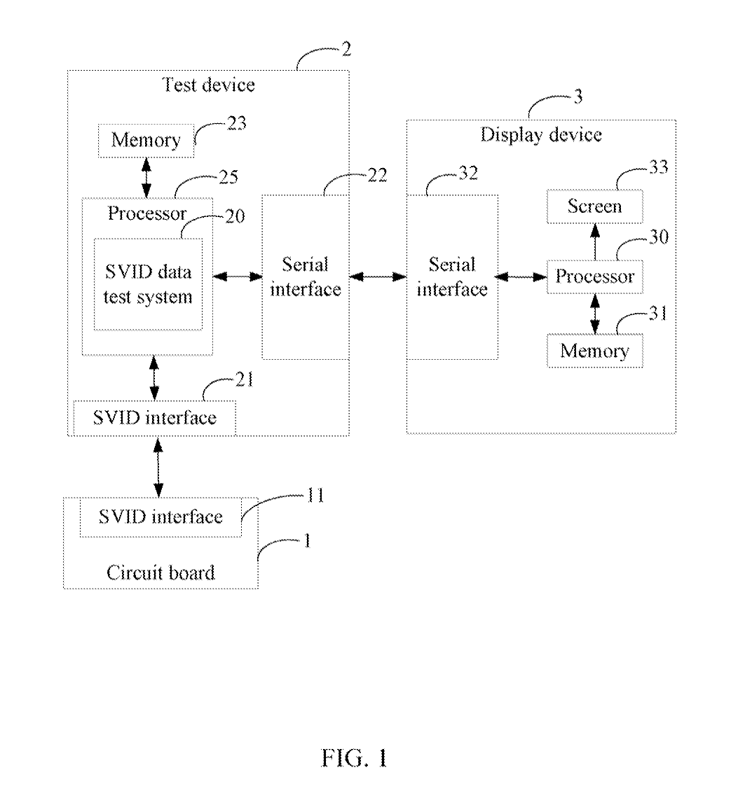

FIG. 1 is a block diagram of a test device including a SVID data test system in accordance with an exemplary embodiment. The SVID data test system 20 is applied on the test device 2 and a display device 3, and is utilized to monitor power supply of a tested device, such as a circuit board 1. The test device 2 includes an SVID interface 21, a serial interface 22, a memory 23, and a processor 25. The SVID data test system 20 is applied by the processor 25. The test device 2 is electrically connected to the circuit board 1 via the SVID interface 21. The SVID interface 21 may be connected to a number of tested devices (not shown) synchronously. The memory 23 stores data, such as the SVID protocol. The circuit board 1 includes an SVID interface 11. The SVID interface 21 receives SVID signals from the SVID interface 11. The SVID signals represent characteristics of the power supply of the circuit board 1. The test device 2 is electrically connected to a display device 3 via the serial interface 22.

The display device 3 includes a processor 30, a memory 31, a serial interface 32, and a screen 33. The processor 30 controls the display device 3 to work. The memory 31 stores data. The display device 3 is electrically connected to the test device 2 via the serial interface 32. The screen 33 displays information. The display device 3 and the test device 2 establish a two-way communication connection.

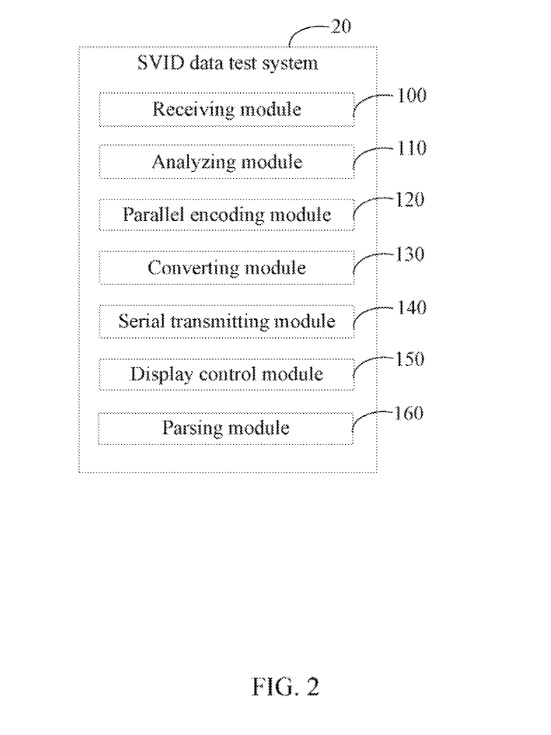

As shown in FIG. 2, the SVID data test system 20 includes a receiving module 100, an analyzing module 110, a parallel encoding module 120, a converting module 130, a serial transmitting module 140, a display control module 150, and a parsing module 160.

The receiving module 100 receives the SVID signals generated from the circuit board 1 via the SVID interface 21. The analyzing module 110 analyzes the SVID signals to obtain nine bit real signals in accordance with the SVID protocol. In the embodiment, the analyzing module 110 is a complex programmable logic device (CPLD), such as an EPM570T100C5N chip.

The parallel encoding module 120 performs parallel encoding on the nine bit real signals to obtain nine bit parallel signals. The converting module 130 converts the nine bit parallel signals to nine bit serial signals. In the embodiment, the serial signal is a universal serial bus (USB) signal and is binary, and both the serial interfaces 22, 32 are USB interfaces. The converting module 130 is a single-chip microcomputer. The serial transmitting module 140 transmits the nine bit serial signals to the serial interface 22 in sequence. The display control module 150 transmits the nine bit serial signals and sends a display command to the processor 30 of the display device 3. The parsing module 160 parses the nine bit serial signals to obtain a packet in hexadecimal and controls the screen 33 to display the packet in response to the display command, thus, a user can determine the characteristics of the power supply of the circuit board 1 according to the packet displayed on the display device 3.

The nine bit serial signals includes a four bit address, a four bit command, and a one bit ACK. The four bit address is located from 0000-1111, the four bit command is located from 0000-1111, and the one bit ACK is “0” or “1”. For example, when the four bit address is “0000”, the SVID interface 21 is pointed to a device “A”; when the four bit address is “1111”, the SVID interface 21 is pointed to a device “B”. When the four bit command is “0001”, a command of reading a voltage of the device “A” is sent; when the four bit command is “0010”, a command of writing a voltage of the device “B” is sent. When the bit ACK is “0”, the device “A” or “B” has received the command and generates a feedback. When the bit ACK is “1”, the device “A” or “B” has not received a command and there was no response.

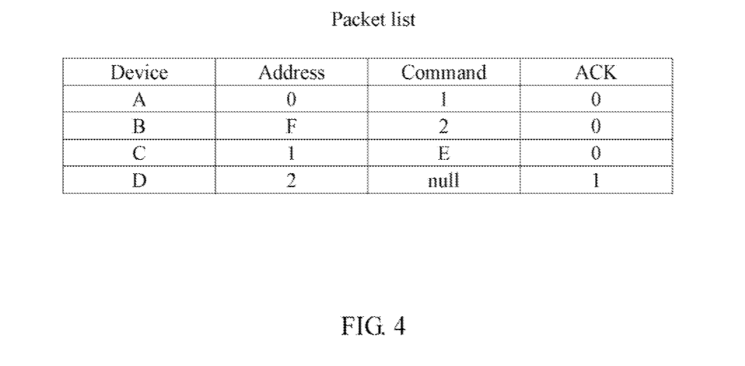

As shown in FIG. 4, the test device 20 is respectively connected to four tested devices and determines characteristics of the power supply of the four tested devices, and the display device 3 displays a packet list reflecting the characteristics of the power supply of the tested devices. The packet list includes four columns. A device column represents a device, an address column represents a hexadecimal, a command column represents a hexadecimal, and an ACK column represents whether or not there was a response to the command. For example, for the device “B”, a number “1111” of the four bit address of the serial signals is represented in hexadecimal as “F”, and a number “00010” of the four bit address of the serial signals is represented in hexadecimal as “2”.

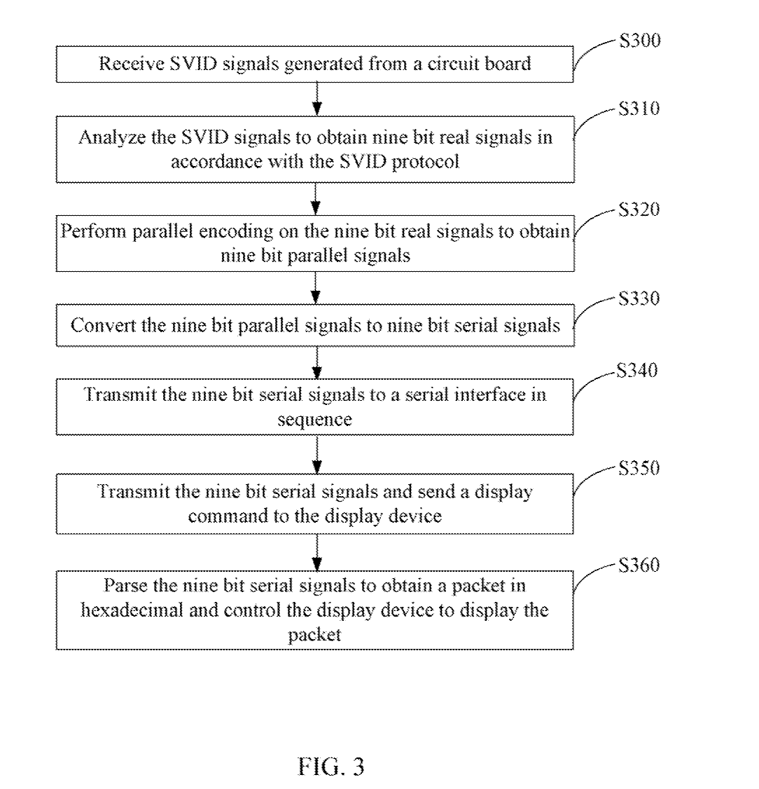

FIG. 3 is a flowchart of a SVID data test method adapted for the SVID data test system of FIG. 2. In step S300, the receiving module 100 receives the SVID signals generated from the circuit board 1 via the SVID interface 21. In step S310, the analyzing module 110 analyzes the SVID signals to obtain nine bit real signals in accordance with the SVID protocol.

In step S320, the parallel encoding module 120 performs parallel encoding on the nine bit real signals to obtain nine bit parallel signals. In step S330, the converting module 130 converts the nine bit parallel signals to nine bit serial signals.

In step S340, the serial transmitting module 140 transmits the nine bit serial signals to the serial interface 22 in sequence. In step S350, the display control module 150 transmits the nine bit serial signals and sends a display command to the display device 3 to display the nine bit serial signals.

In step S360, the parsing module 160 parses the nine bit serial signals to obtain a packet in hexadecimal and controls the screen 33 to display the packet in response to the display command. Therefore, when the test device 2 is connected to a tested device, the display device 3 displays a packet which reflects the characteristics of the power supply of the tested device; when the test device 2 is connected to a number of tested devices, the display device 3 displays a packet list which reflects the characteristics of the power supply of the number of tested devices, thus the user can quickly determine the characteristics of the power supply of a tested device from the packet.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A SVID data test system, wherein the SVID data test system is applied on a test device and a display device, the test device is electrically connected to a tested device via a SVID interface and is electrically connected to the display device via a serial interface, the system comprising:
a receiving module to receive SVID signals generated from the tested device;
an analyzing module to analyze the SVID signals to obtain nine bit real signals in accordance with the SVID protocol;
a parallel encoding module to perform parallel encoding on the nine bit real signals to obtain nine bit parallel signals;
a converting module to convert the nine bit parallel signals to nine bit serial signals;
a serial transmitting module to transmit the nine bit serial signals to the serial interface in sequence;
a display control module to transmit the nine bit serial signals and send a display command to the display device; and
a parsing module to parse the nine bit serial signals to obtain a packet in hexadecimal and control the display device to display the packet in response to the display command;
these modules of the SVID data test system is to executed by at least one processor.

2. The SVID data test system as recited in claim 1, wherein the analyzing module is a complex programmable logic device.

3. The SVID data test system as recited in claim 1, wherein the analyzing module is an EPM570T100C5N chip.

4. The SVID data test system as recited in claim 1, wherein the serial signal is a universal serial bus signal.

5. The SVID data test system as recited in claim 1, wherein the converting module is a single-chip microcomputer.

6. The SVID data test system as recited in claim 1, wherein the packet comprises four columns, a device column represents a device, an address column represents a hexadecimal, a command column represents a hexadecimal, and an ACK column represents whether or not responding the command

7. A SVID data test method applied on a test device and a display device, wherein the test device is electrically connected to a tested device via a SVID interface and is electrically connected to the display device via a serial interface, the method comprising:
receiving SVID signals generated from the tested device;
analyzing the SVID signals to obtain nine bit real signals in accordance with the SVID protocol;
performing parallel encoding on the nine bit real signals to obtain nine bit parallel signals;
converting the nine bit parallel signals to nine bit serial signals;
transmitting the nine bit serial signals to the serial interface in sequence;
transmitting the nine bit serial signals and sending a display command to the display device; and
parsing the nine bit serial signals to obtain a packet in hexadecimal and controlling the display device to display the packet in response to the display command

8. The SVID data test method as recited in claim 7, wherein the serial signal is a universal serial bus signal.

9. The SVID data test method as recited in claim 7, wherein the packet comprises four columns, a device column represents a device, an address column represents a hexadecimal, a command column represents a hexadecimal, and an ACK column represents whether or not responding the command.
